(19) United States
(12) Patent Application Publication
(10) Pub. No.: US 2008/0154816 A1
(43) Pub. Date: Jun. 26, 2008

(54) ARTIFICIAL NEURAL NETWORK WITH ADAPTABLE INFINITE-LOGIC NODES

(75) Inventors: Weimin Xiao, Hoffman Estates, IL (US); Magdi A. Mohamed, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/554,724

(22) Filed: Oct. 31, 2006

(51) Int. Cl. G06F 15/18; G06N 3/02

(52) U.S. Cl. 706/15

(57) ABSTRACT

An Artificial Neural Network (110) includes a hidden layer (209) of distance metric computer nodes (210, 214, 218) that evaluate distances of a input vector from metric space centers, an additional layer of adaptable infinite logic aggregators (236, 240, 244) that combine the per-unit distance output values by the distance metric computer nodes (210, 214, 218) using adaptable infinite logic. In certain embodiments the adaptable infinite logic aggregators include veracity signal pre-processors (602, 702) that can be configured to make inferences in a continuum from positive to negative including no inference from each distance and infinite logic connective signal processors (604, 702) that can implement a continuum of functions covering the range of fuzzy logic union operators, fuzzy logic intersection operators, and all linear and nonlinear averaging operators between them. Control parameters (e.g., αᵢ, βᵢ, λ_{A}, λ_{D}, wᵢ) of the distance metric computer nodes and adaptable infinite logic aggregators can be determined by direct search optimization, using training data.

### FIELD OF THE INVENTION

The present invention relates generally to Artificial Neural Networks for technical applications.

### BACKGROUND

Commercially available computers are, with few exceptions, of the Von Neumann type. Von Neumann type computers include a memory and a processor. In operation, instructions and data are read from the memory and executed by the processor. Von Neumann type computers are suitable for performing tasks that can be expressed in terms of sequences of logical, or arithmetic steps. Generally, Von Neumann type computers are serial in nature; however, if a function to be performed can be expressed in the form of a parallel algorithm, a Von Neumann type computer that includes a number of processors working cooperatively in parallel can be utilized. For certain categories of problems, algorithmic approaches suitable for implementation on a Von Neumann machine have not been developed. For other categories of problems, although algorithmic approaches to the solution have been conceived, it is expected that executing the conceived algorithm would take an unacceptably long period of time. Inspired by information gleaned from the field of neurophysiology, alternative means of computing and otherwise processing data or signals known as neural networks were developed. Neural networks generally include one or more inputs, and one or more outputs, and one or more processing nodes intervening between the inputs and outputs. The foregoing are coupled by signal pathways characterized by weights. Neural networks that include a plurality of inputs, and that are aptly described as parallel due to the fact that they operate simultaneously on information received at the plurality of inputs, have also been developed. Neural networks are able to handle tasks that are characterized by a high input data bandwidth. In as much as the operations performed by each processing node is relatively simple and is predetermined, there is the potential to develop very high speed processing nodes and from them high speed and high input data bandwidth neural networks.

There is generally no overarching theory of neural networks that can be applied to design neural networks to perform a particular task. Designing a neural network involves specifying the number and arrangement of nodes, and the weights that characterize the interconnection between nodes. A variety of stochastic methods have been used in order to explore the space of parameters that characterize a neural network design in order to find suitable choices of parameters, that lead to satisfactory performance of the neural network.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a pattern recognition system according to an embodiment of the invention;

FIG. 2 is a block diagram of an artificial neural network used in the pattern recognition system shown in FIG. 1 according to an embodiment of the invention;

FIG. 3 is scatter plot of feature vectors in a two-dimensional feature vector space;

FIG. 4 is a detailed block diagram of a configurable feature vector distance metric computer used in the neural network shown in FIG. 2;

FIG. 5 is a 2-D graph showing two loci of points at fixed at non-Euclidean distances from two prototype vectors that are computed by the configurable feature vector distance computer shown in FIG. 4 in the feature vector space along with a decision surface determined by the non-Euclidean distances from the two prototype vectors;

FIG. 6 is a high level block diagram of an adaptable infinite logic signal processor used in the neural network shown in FIG. 2 according to an embodiment of the invention;

FIG. 7 is a block diagram of a hardware implementation of the adaptable infinite logic signal aggregator shown in FIG. 6;

FIG. 8 is a graph including a plot of the Identity Function and several plots of an adaptable infinite logic inverter function;

FIG. 9 is a graph including several plots showing the input-output response of a veracity signal processor that is part of the adaptable infinite logic signal aggregator shown in FIGS. 6-7;

FIG. 10 shows 2-D surface plots of the input-output relation of the infinite logic connective signal processor that is part of the adaptable infinite logic signal aggregator shown in FIGS. 6-7;

FIG. 11 shows contour plots at which the input-output relation of the infinite logic connective signal processor is equal to the MIN function for a few positive values of a control parameter of the infinite logic connective signal processor;

FIG. 12 shows contour plots at which the input-output relation of the infinite logic connective signal processor is equal to the MAX function for a few negative values of the control parameter of the infinite logic connective signal processor;

FIGS. 13-18 show 2-D surface plots of the input-output relation of the adaptable infinite logic signal aggregator shown in FIGS. 6-7 with specific values of configuration settings;

FIG. 19 is a block diagram of a system for training the artificial neural network shown in FIG. 2;

FIG. 20 is a flowchart of a method of training the artificial neural network shown in FIG. 2;

FIG. 21 is a block diagram of a neural network used for regression according to an embodiment of the invention;

FIG. 22 is a block diagram of an implementation of the configurable feature vector distance metric computer that implements efficient recursive computation;

FIG. 23 is a block diagram of an implementation of an infinite logic connective signal processor that is used in the adaptable infinite logic signal processor shown in FIG. 6 that implements efficient recursive computation; and

FIG. 24 is a block diagram of a computer that is used to run software implementations of the systems disclosed herein according to certain embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to artificial neural networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of artificial neural networks described herein. The non-processor circuits may include, but are not limited to signal drivers, clock circuits, power source circuits, and user input devices. As such, these functions may be interpreted as steps of a method to perform signal processing. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and Integrated Circuits (ICs) with minimal experimentation.

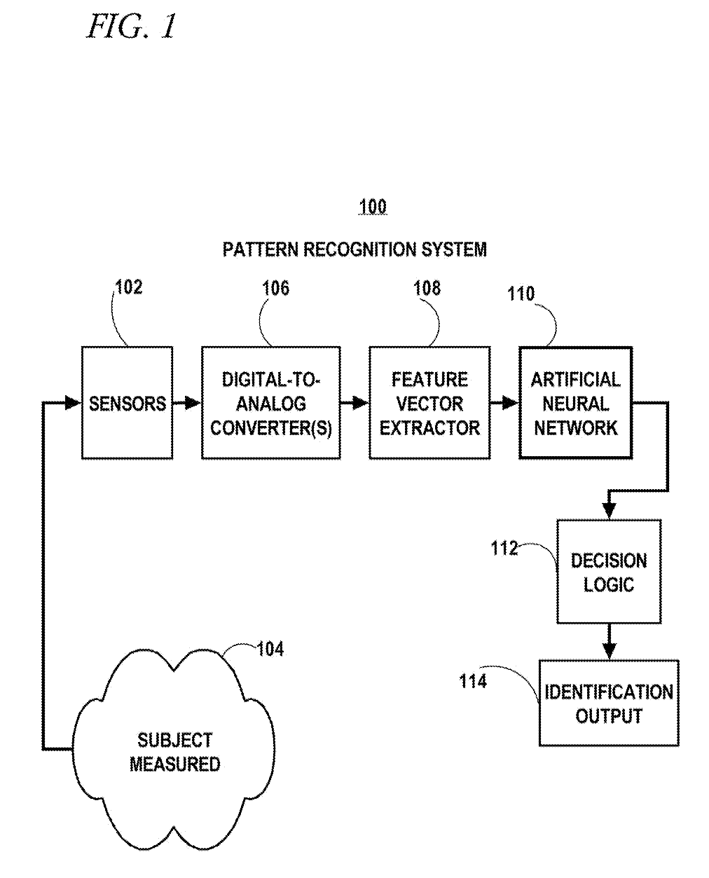

FIG. 1 is a block diagram of a pattern recognition system 100 according to an embodiment of the invention. The pattern recognition system 100 has one or more sensors 102 that are used to collect measurements from subjects to be recognized 104. By way of example, subjects 104 can be living organisms such as persons, spoken words, handwritten words, animate or inanimate objects. The sensors 102 can take different forms depending on the subject. By way of example, various types of fingerprint sensors can be used to sense finger prints, microphones can be used to sense spoken words, cameras can be used to image faces, and radar can be used to sense airplanes and other objects.

The sensors 102 are coupled to one or more digital-to-analog converters (D/A) 106. The D/A 106 is used to digitize the data collected by the sensors 102. Multiple D/A's 106 or multi-channel D/A's 106 may be used if multiple sensors 102 are used. By way of example, the output of the D/A 106 can take the form of time series data and images. The D/A 106 is coupled to a feature vector extractor 108. The feature vector extractor 108 performs lossy compression on the digitized data output by the D/A 106 to produce a feature vector which compactly represents information derived from the subject 104. Various feature vector extraction programs that are specific to particular types of subjects are known to persons having ordinary skill in the relevant art.

The feature vector extractor 108 is coupled an artificial neural network (ANN) 110 with adaptable infinite-logic nodes. According to certain embodiments when two classes of patterns are to be distinguished, (e.g., gender recognition, video key-frame detection, landmine detection, speaker verification, handwritten signature verification, and medical diagnostics, where two classes could be male and female, good and bad, pass and fail, etc.) the ANN 110 includes a single adaptable infinite-logic output node that produces output in a range having two sub-ranges that are mapped to the two classes to be distinguished. According to other embodiments, when the system 100 distinguishes more than two classes of patterns (e.g., handwritten characters, uttered phonemes) the ANN 110 has multiple adaptable infinite-logic output nodes and each node is configured to output a particular value (e.g., a minimum, or maximum value of an output range) in response to a particular class of pattern.

Decision logic 112 is coupled to the output node(s) of the ANN 110 the decision logic implements rules for identifying classes of patterns based on the output of the ANN 110. For example, in the aforementioned case that system 100 is used to recognize just two classes of patterns, the decision logic 112 can produce a signal (e.g., a binary ID) identifying a first class when the output of the single output node of the ANN 110 is in a first range (e.g., zero to ½) and can produce a signal identifying a second class when the output of the single output node of the ANN 110 is in a second range (e.g., ½ to one.) Alternatively, in the case that the system 100 is used to recognize more than two classes of patterns, the decision logic 112 can produces a signal (e.g. binary ID) identifying a class associated with the adaptable infinite-logic output node (among multiple such nodes) that produced the lowest (or highest) output. Alternatively, additional criteria can be incorporated into the decision logic, for example, for a classed to be identified, the output of the associated adaptable infinite-logic output node may be required to pass an inequality test (e.g., be less than or greater than a stored limit.)

An identification output 114 is coupled to the decision logic 112. Information identifying a particular vector-subspace (which corresponds to a particular class or individual) is output via the output 114. The identification output 114 can, for example, comprise a computer monitor. Software that maps the signal (e.g., binary ID) output by the decision logic to a stored name and/or picture, for example, may be provided.

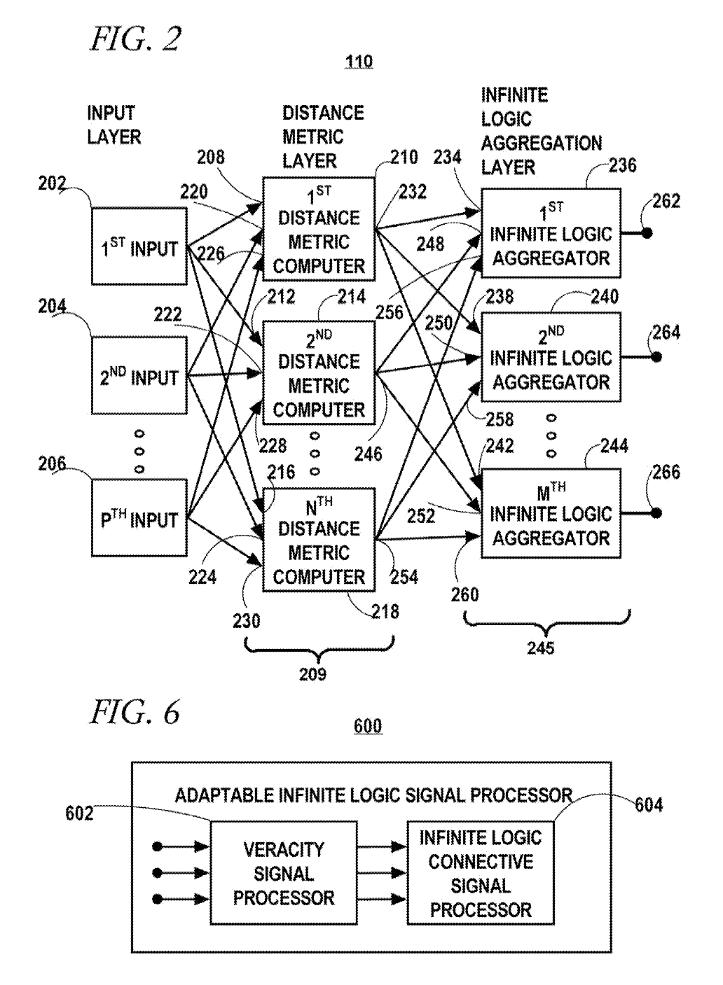

FIG. 2 is a block diagram of the artificial neural network 110 used in the pattern recognition system shown in FIG. 1 according to an embodiment of the invention. As shown in FIG. 2 the ANN 110 comprises a first ANN input 202, a second ANN input 204, and an P^{TH} ANN input 206. Although three ANN inputs 202, 204, 206 are shown for purposes of illustration, the number of inputs is variable depending on the application of the ANN 110. Generally, the number of ANN inputs is equal to the dimensionality of the input signal vectors (termed “feature vectors” in pattern recognition applications). In the pattern recognition system 100, each ANN input 202, 204, 206 suitably receives an element of feature vectors that are output by the feature vector extractor 108.

The first ANN input 202 is connected to a first input 208 of a first distance metric computer 210, a first input 212 of a second distance metric computer 214 and a first input 216 of an N^{TH} distance metric computer 218. Similarly, the second ANN input 204 is connected to a second input 220 of the first distance metric computer 210, a second input 222 of the second distance metric computer 214 and a second input 224 of the N^{TH} distance metric computer 218; and the P^{TH} ANN input 206 is connected to a P^{TH} input 226 of the first distance metric computer 210, a P^{TH} input 228 of the second distance metric computer 214 and a P^{TH} input 230 of the N^{TH} distance metric computer 218. The distance metric computers 210, 214, 218 form a hidden layer 209 of the ANN 110. Although three distance metric computers 210, 214, 218 are shown for purposes of illustration, the number of distance metric computers 210, 214, 218 may be varied. Generally, the number of distance metric computers is equal to the number of clusters in the space of feature vectors. Each distance metric computer 210, 214, 218 computes a distance of an input feature vector from a point (center) in the feature vector space (e.g., a cluster center). The distance may be Euclidean, but in certain embodiments, as will be described in more detail below, the distance is a weighted distance metric.

An output 232 of the first distance metric computer 210 (at which a computed distance is output) is coupled to a first input 234 of a first infinite logic aggregator 236, a first input 238 of a second infinite logic aggregator 240, and a first input 242 of an M^{TH} infinite logic aggregator 244. Similarly an output 246 of the second distance metric computer 214 is coupled to a second input 248 of the first infinite logic aggregator 236, a second input 250 of the second infinite logic aggregator 240 and a second input 252 of the M^{TH} infinite logic aggregator 244; and an output 254 of the N^{TH} distance metric computer 218 is coupled to a N^{TH} input 256 of the first infinite logic aggregator 236, a N^{TH} input 258 of the second infinite logic aggregator 240 and a N^{TH} input 260 of the M^{TH} infinite logic aggregator 244. The infinite logic aggregators 236, 240, 244 form an output layer 245 of the ANN 110. The first, second and M^{TH} infinite logic aggregators 236, 240, 244 have a first output 262, a second output 264 and a M^{TH} output 266 respectively. The outputs 262, 264, 266 are used to output the result of infinite logic operations performed by the infinite logic aggregators 236, 240, 244. Although three infinite logic aggregators 236, 240, 244 are shown for purposes of illustration a different number may be used. As alluded to above, a single infinite logic aggregator may be used in the output layer 245 if the ANN 110 is being used to recognize two classes of subjects. If more than two classes of subjects are being recognized then an infinite logic aggregator may be provided for each class to be recognized. In such a case the infinite logic aggregator that produces the lowest (alternatively highest) output indicates the correct classification of the subject 104 being recognized. The infinite logic aggregators 236, 240 244 can implement a variety of infinite logic rules for combining the distances computed by the distance metric computers 210, 214, 218 in order to judge whether a measured subject belongs to a classification. Expressed in words, such rules include, for example: “close to at least one of a select group of cluster centers”, “close to all of a select group of cluster centers”, or “close to one cluster center but far from another cluster center.”

As shown in FIG. 2 each ANN input 202, 204, 206 is connected to all of the distance metric computers 210, 214, 218 and each distance metric computer 210, 214, 218 is connected to all of the infinite logic aggregators 236, 240, 244. This is termed fully connected. Alternatively, the ANN 110 is not fully connected.

Co-pending patent application Ser. No. ______ entitled “Configurable Infinite Logic Signal Processing Network and Genetic Computing Method of Designing the Same” to Magdi Mohamed et al discloses networks that include one or more adaptable infinite logic connective signal processors 704 in combination with one or more infinite logic inverters 706 forming an infinite logic network. As disclosed in that application the topology of the network can be determined by a gene expression programming algorithm that uses a hybrid Genetic Algorithm (GA)/Differential Evolution (DE) subprogram to set control parameter values. According to an alternative embodiment of the invention such infinite logic networks are used in the ANN 110 in place of the infinite logic aggregators 236, 240, 244.

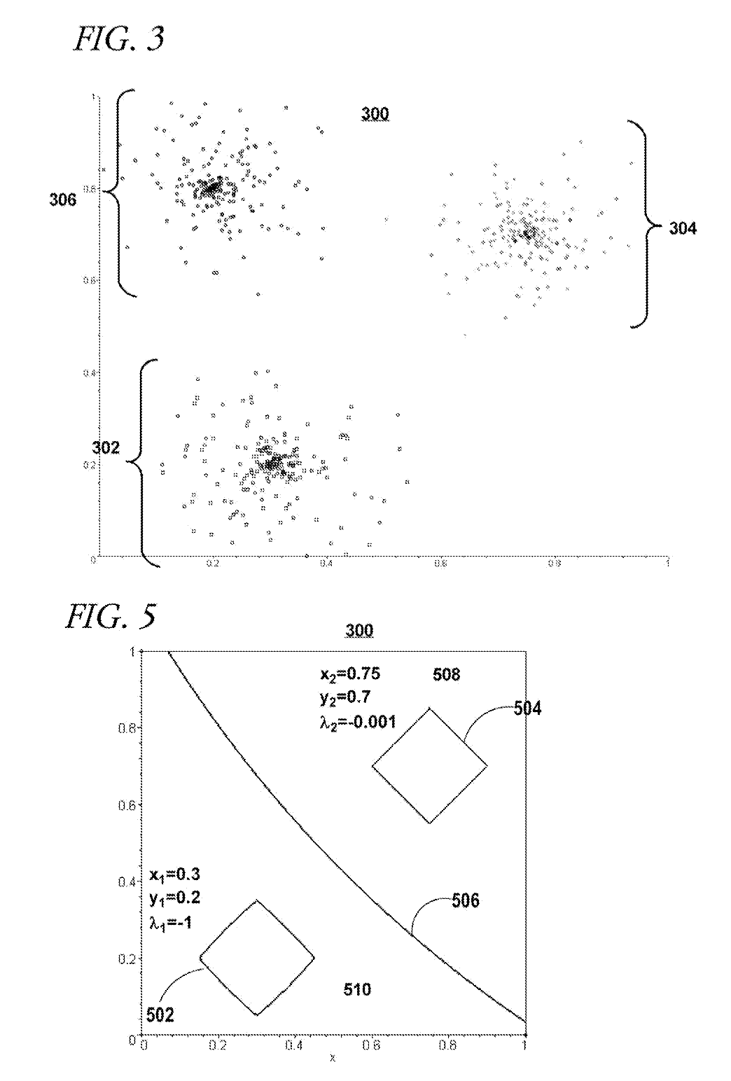

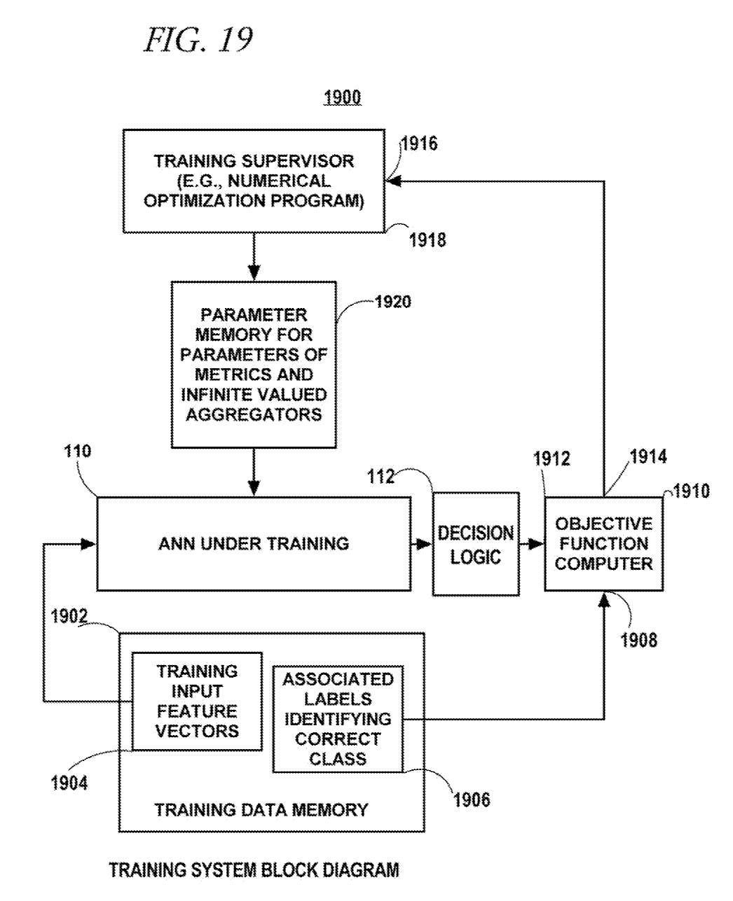

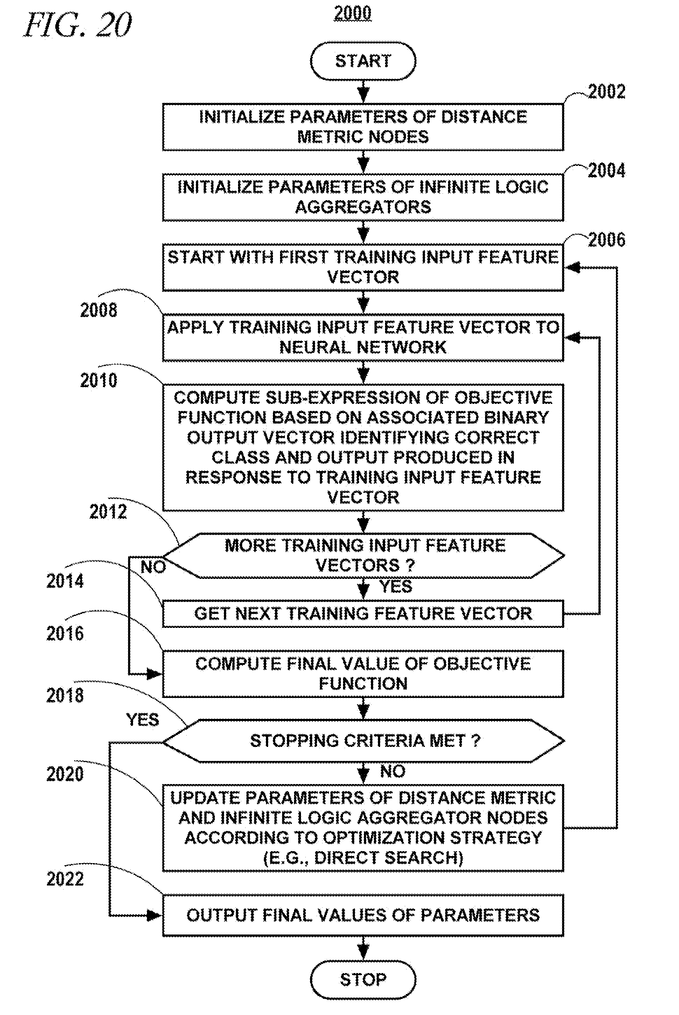

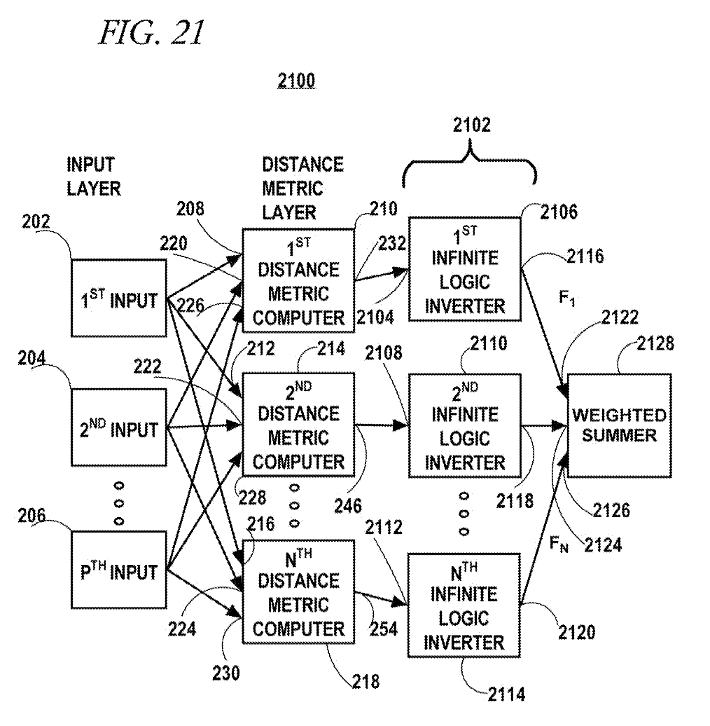

FIG. 3 is scatter plot of feature vectors in a two-dimensional feature vector space 300. (Alternatively, FIG. 3 could represent a two dimensional projection of higher dimensional feature vectors.) The scatter plot includes a first cluster 302, a second cluster 304 and a third cluster 306. Each of the three clusters 302, 304, 306 may be training vectors from a separate classification of subject to be recognized by the system. Training vectors are class labeled feature vectors that are used to tune parameters of the ANN 110 in order to configure the ANN to be used in classification. Each cluster has center which may be used to represent the cluster. There is some variance associated with each dimension of each cluster, because of natural variance of subjects within a particular classification and because of measurement noise. Each cluster center may be used as a feature vector point with respect to which the distance metric computers 210, 214, 218 measure distance. Alternatively, other points, e.g., points determined by optimization may be used as the center with respect to which the distance metric computers 210, 214, 218 measure distance. Optimum points can be chosen using an objective function that minimize misclassifications. Training is described below with reference to FIGS. 19-20. Although as shown in FIG. 3 the clusters 302, 304, 306 are well separated, in practice clusters may be close to each other making classification more difficult. A particular classification of subjects can also include more than one cluster of feature vectors in certain cases.

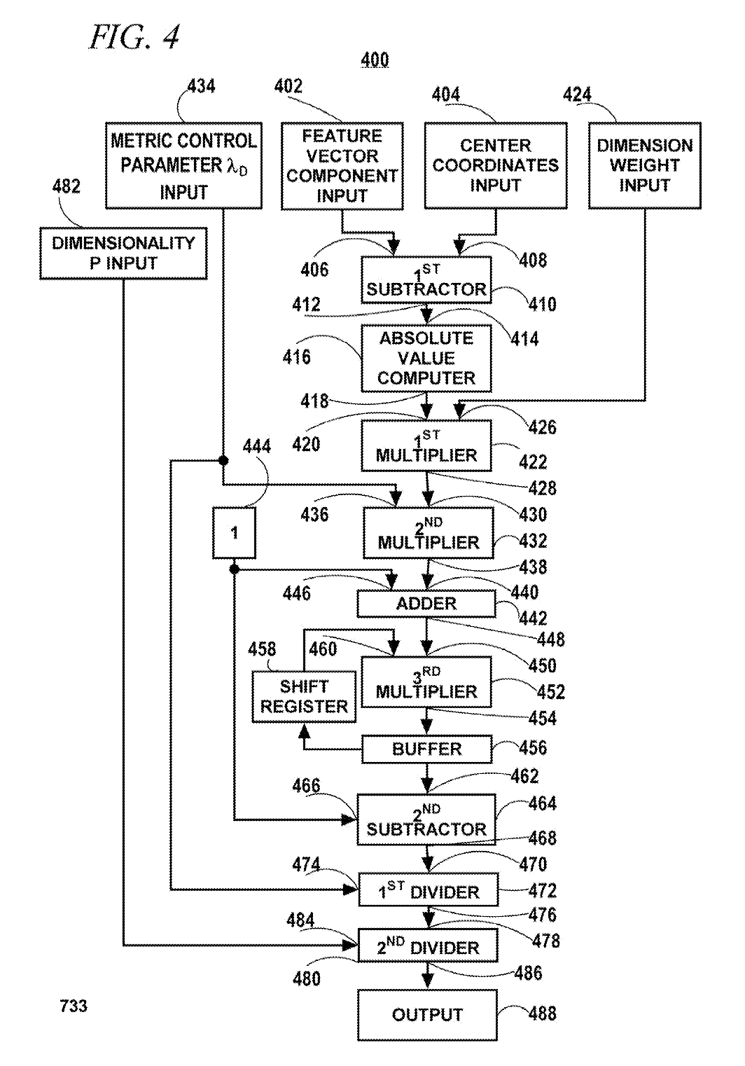

FIG. 4 is a detailed block diagram of a configurable feature vector distance metric computer 400 that can be used in the neural network 110 shown in FIG. 2 as the first, second and/or N^{TH} distance metric computers 210, 214, 218. A feature vector component input 402 and a center coordinate input 404 are coupled to a first input 406 and a second input 408, respectively, of a first subtracter 410. The feature vector component input 402 receives components sequentially, and the center coordinate input 404 receives coordinates sequentially. The center coordinates define a point in the feature vector space with respect to which distance is measured by the feature vector distance metric computer 400. In response to each feature vector component and center coordinate, the first subtracter 410 produces a difference at a first subtracter output 412. The first subtracter output 412 is coupled to an input 414 of an absolute value computer 416. An output 418 of the absolute value computer 416 is coupled to a first input 420 of a first multiplier 422. A dimension weight input 424 of the configurable feature vector distance computer 400 is coupled to a second input 426 of the first multiplier 422. The first multiplier 422 sequentially receives (e.g., from a multibit shift register, not shown) component differences computed by the absolute value computer 416 and synchronously receives corresponding dimension weights from the dimension weight input 424. An output 428 of the first multiplier 422 is coupled to a first input 430 of a second multiplier 432. An input for a metric control parameter 434 (a scalar, denoted herein as AD) is coupled to a second input 436 of the second multiplier 432. An output 438 of the second multiplier 432 is coupled to a first input 440 of an adder 442. A fixed value 444 (e.g., unity) is coupled to a second input 446 of the adder 442. An output 448 of the adder 442 is coupled to a first input 450 of a third multiplier 452. An output 454 of the third multiplier 452 is coupled to a buffer 456 which is coupled through a shift register 458 to a second input 460 of the third multiplier 452. An output of the shift register 458 is initialized to one. Thus, the third multiplier 452 operates recursively. When all the feature vector components and corresponding center coordinates and dimension weights have been fed into configurable feature vector distance computer 400 a final product will be stored in the buffer 456. The buffer 456 is coupled to a first input 462 of a second subtracter 464. The fixed value 444 (e.g., unity) is coupled to a second input 466 of the second subtracter 464. The second subtracter 464 subtracts the fixed value 444 from the product received from the buffer 456. An output 468 of the second subtracter 464 is coupled to a numerator input 470 of a first divider 472. The input for the metric control parameter 434 is coupled to a denominator input 474 of the first divider 472. The first divider 472 divides the value obtained at the first input 470 by the metric control parameter received from the input 434. An output 476 of the first divider 472 is coupled to a numerator input 478 of a second divider 480. A vector dimensionality input 482 of the configurable feature vector distance computer is coupled to a denominator input 484 of the second divider 480. An output 486 of the second divider 480 is coupled to an output 488 of the configurable feature vector distance computer 400.

The operation of the configurable feature vector distance computer 400 can be described by the following equation:

$${d}_{{λ}_{D}} ( x , y ) = \frac{{\prod }_{i = 1}^{P} ( 1 + {λ}_{D} {w}_{i} \vert {x}_{i} - {y}_{i} \vert ) - 1}{P {λ}_{D}} \qquad EQU . 1$$

where,
λ_{D}ε [−1,0) is the metric control parameter;
xᵢε [0,1] is an i^{th} component of a first feature vector denoted x
yᵢε [0,1] is an i^{th} component of a second feature vector denoted y;
P is the dimensionality of first and second feature vectors;
wᵢε [0,1] is an i^{th} dimension weight; and
d_{λD} (x,y) ε [0,P] is a per-unit distance between the first feature
   vector and the second feature vector, computed by the Q-metric.

One of the first and second P-dimensional feature vectors in equation one (e.g., y) is the center input through the center coordinate input 404 and one (e.g., x) can be the feature vector input through the feature vector component input 402.

Note that for equation one the metric control parameter λ_{D} is restricted to being less than zero. An alternative configurable feature vector distance computer is described by the following equation:

$${d}_{{λ}_{D}} ( x , y ) = \{ \begin{matrix} \frac{{\prod }_{i = 1}^{P} ( 1 + {λ}_{D} {w}_{i} \vert {x}_{i} - {y}_{i} \vert ) - 1}{P {λ}_{D}} & {λ}_{D} = [ - 1 , 0 ) \\ \frac{1}{P} {\sum }_{i = 1}^{P} {w}_{i} \vert {x}_{i} - {y}_{i} \vert & {λ}_{D} = 0\end{matrix} \qquad EQU . 1.1$$

According to equation 1.1 when the metric control parameter λ_{D} is equal to zero the configurable feature vector distance computer 400 becomes a coordinate difference absolute value weighted sum (weighted Manhattan distance) computer. In order to implement a configurable feature vector distance computer according to equation 1.1 the output of the first multiplier 422 can be routed to another summer (not shown) in the case that λ_{D}=0. Note that as λ_{D} approaches zero the first expression of equation 1.1 asymptotically approaches the weighed sum given the second expression of equation 1.1.

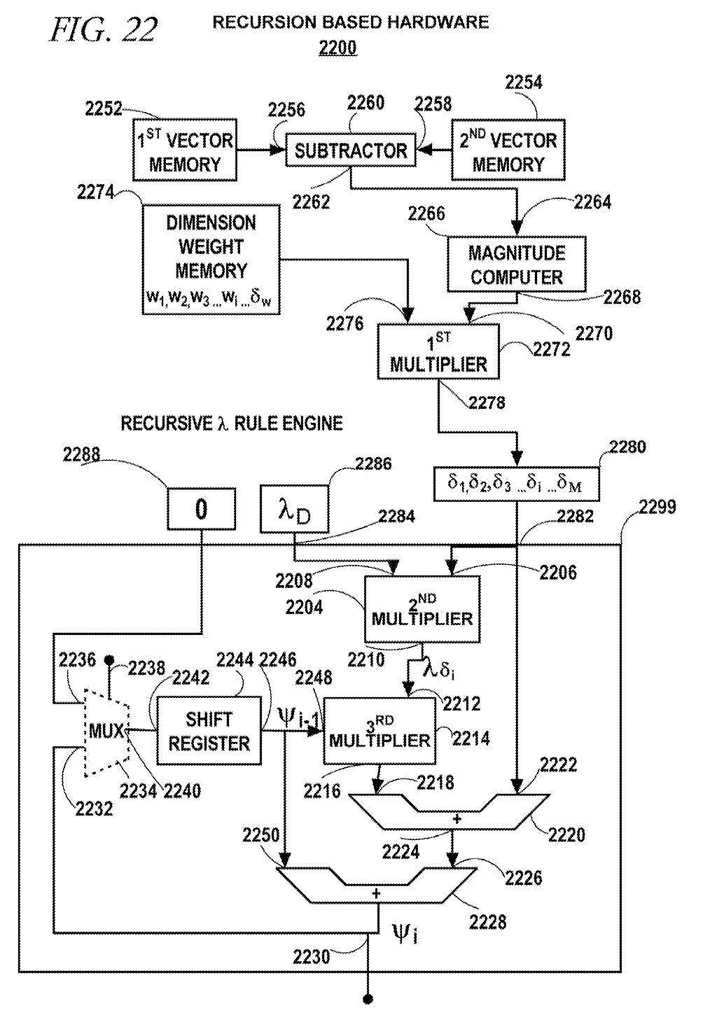

Alternative to the hardware shown in FIG. 4, the configurable feature vector distance computer 400 either as described by equation 1 or equation 1.1 can be implemented in software, or in hardware in a different form. FIG. 22 described herein below is one alternative.

FIG. 5 is another 2-D graph showing the feature vector space 300 that is shown in FIG. 3. A first locus 502 shows points at a fixed distance (numerically 0.15) from a first prototype vector at coordinates (0.3, 0.2). The distance is the non-Euclidean distance computed by the configurable feature vector distance computer 400. Note that the first prototype vector (0.3, 0.2) corresponds to the first cluster 302 shown in FIG. 3. In the case of the first locus 502 the metric control parameter λ_{D} was set to −1.0.

A second locus 504 shows points at the same fixed distance (0.15) from a second prototype vector at coordinates (0.75, 0.7). The second prototype vector (0.75, 0.7) corresponds to the second cluster 304 shown in FIG. 3. In the case of the second locus 504 a different setting of the metric control parameter λ_{D}=−0.001 was used.

A decision surface 506 divides the feature vector space 300 into an upper right portion 508 in which the distance to the second prototype vector (0.75, 0.7) as measured using the associated control parameter setting −0.001 is closer than the distance to first prototype vector (0.3, 0.2) as measured using the associated control parameter setting −1.0 and a lower left portion 510 in which the opposite is true. Note that because the control parameter λ_{D} settings used to measure distance from the two prototype vectors are different the decision surface 506 is not linear (and in the case of higher dimensions would not be hyperplanar). Thus, control parameter λ_{D} setting allows the decision boundaries between different prototype vectors (or more generally arbitrary vectors in a feature vector space) to be controlled. This allows the boundaries to be more accurately shaped to the distributions of feature vectors within two clusters or within two classes. In the context of the ANN this allows for improved performance of the hidden layer 209 of distance metric computers 210, 214, 218.

Alternatively, instead of using the configurable feature vector distance computer described by equation 1, equation 1.1 and/or shown in FIG. 4 the ANN 110 includes nodes that implement different metrics. For example, the hidden layer nodes 210, 214, 218 of the ANN could implement the Euclidean metric, the weighted Euclidean metric, the p-metric, or the Mahalanobis metric.

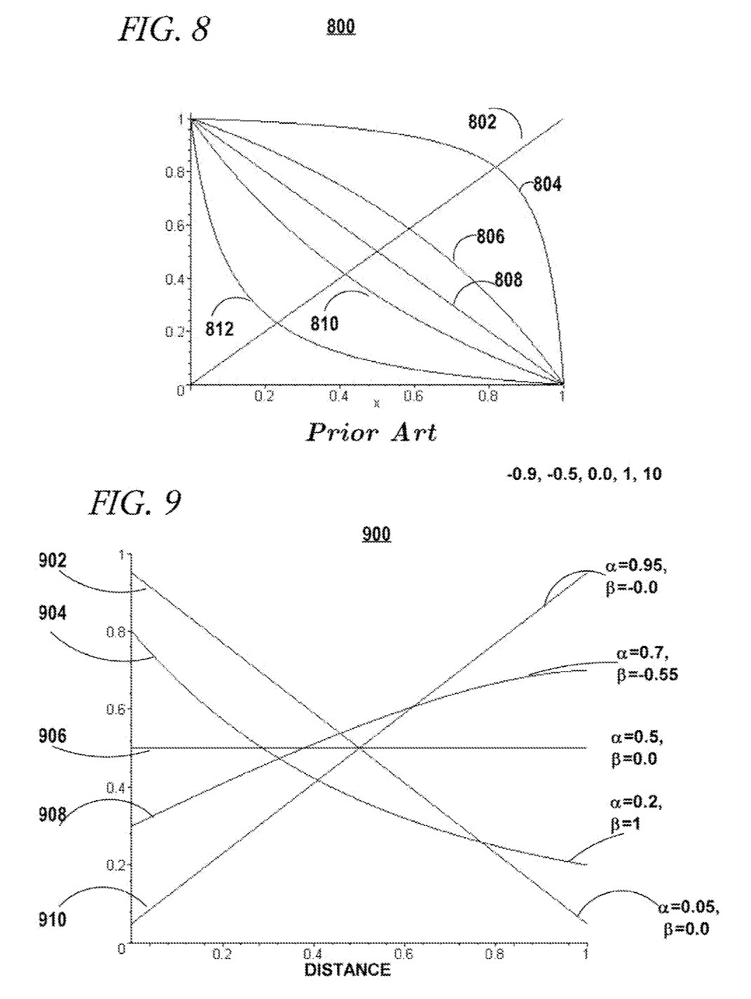

FIG. 6 is a high level block diagram of an adaptable infinite logic signal aggregator 600 used in the ANN 110 shown in FIG. 2 according to an embodiment of the invention. The adaptable infinite logic signal aggregator 600 shown in FIG. 6 can be used as one or more of the output layer nodes 236, 240, 244 of the ANN 110. The adaptable infinite logic signal aggregator 600 includes a veracity signal processor 602 coupled to an infinite logic connective signal processor 604. The veracity signal processor 602 receives separate input from the distance metric computer nodes 210, 214, 218. The veracity signal processor 602 can be configured to produce an output that increases as its input increases or an output that decreases as its input increases. In the former case the input signal is treated as qualitatively truthful, in the latter case the input signal is treated as qualitatively contradictory to the meaning of the output. This will be elucidated below with reference to FIGS. 8-18.

The infinite logic connective signal processor 604 receives the signals output by the veracity signal processor 602 and combines them into a single signal. The infinite logic connective signal processor can perform a range of input-output functions, such as for example, an approximate MIN function, an approximate MAX function or an AVERAGE function.

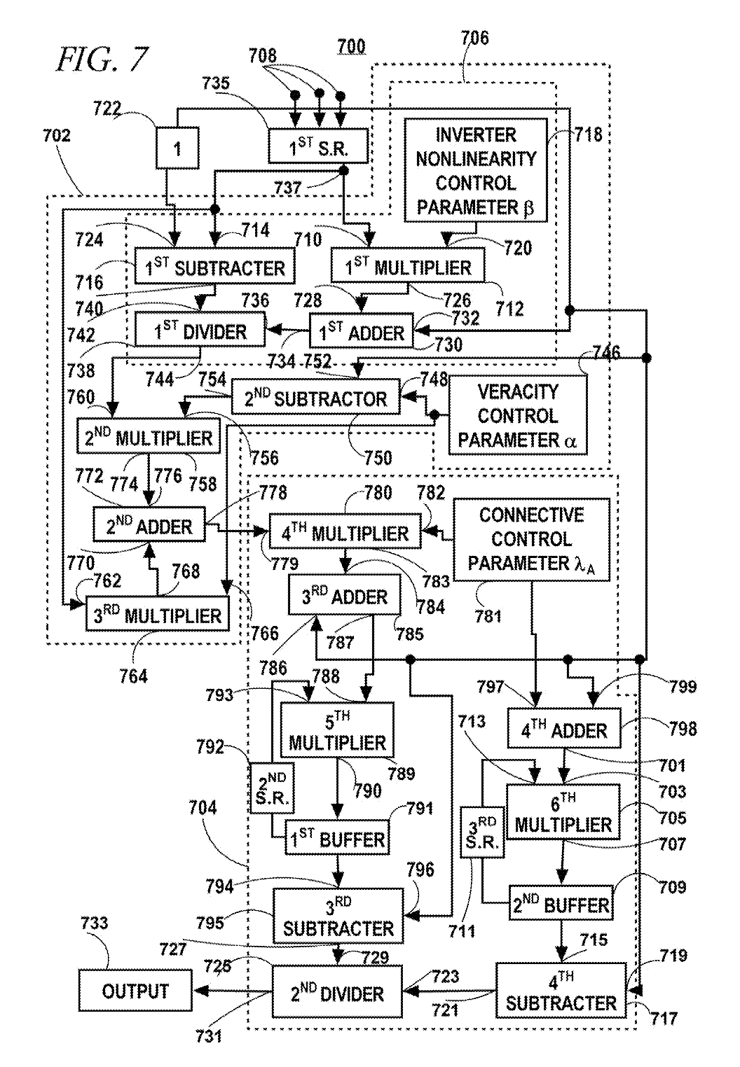

FIG. 7 is a block diagram of a hardware implementation of the adaptable infinite logic signal aggregator 600 shown in FIG. 6. For the purposes of this discussion the hardware implementation is designated by reference numeral 700. As shown in FIG. 7 the infinite logic aggregator 700, comprises a veracity signal processor 702, and an infinite logic connective signal processor 704. The veracity signal processor 702 comprises an infinite logic inverter 706.

A plurality of inputs 708 of the infinite logic aggregator 700 are parallel inputs of a multi-bit first shift register 735. A serial output 737 of the first shift register 735 is coupled to a first input 710 of a first multiplier 712 and to a first input 714 of a first subtracter 716. The inputs 708 of the infinite logic aggregator 700 receive the distances computed by the distance metric computers 210, 214, 218. An inverter nonlinearity control parameter β input 718 is coupled to a second input 720 of the first multiplier 712. A fixed value 722 (e.g., unity) is coupled to second input 724 of the first subtracter 716. The first subtracter 716 serves to subtract the distance received at the first shift register 735 from the fixed value 722 (e.g., unity.) An output 726 of the first multiplier 712 is coupled to a first input 728 of a first adder 730. The fixed value 722 is coupled to a second input 732 of the first adder 730. An output 734 of the first adder 730 is coupled to a denominator input 736 of a first divider 738. An output 740 of the first subtracter 716 is coupled to a numerator input 742 of the first divider 738. An output 744 of the first divider 738 serves as an output of the infinite logic inverter 706. The input-output processing of the infinite logic inverter can be described by the following equation:

$${Inv}_{β} ( d ) = \{ \begin{matrix} \frac{1 - d}{1 + β d} & d \neq 1 \\ 0 & d = 1\end{matrix} \qquad EQU . 3$$

where,
   d ε [0,1], is a feature vector space distance input to the infinite logic inverter 706, applied at one of the inputs 708,
   β ε [−1, +infinity), is the nonlinearity control parameter applied at 718, and
   Inv_{β}(d) ε [0,1] is the output of the signal inverter 706, produced at the output 744 of the first divider 738.

Referring again to FIG. 7, the remaining parts of the veracity signal processor 702 will be described. A veracity control parameter α input 746 is coupled to a first input 748 of a second subtracter 750. The fixed value (e.g., unity) 722 is coupled to a second input 752 of the second subtracter 750. The second subtracter 750 serves to subtract the veracity control parameter α from the fixed value 722. An output 754 of the second subtracter 750 is coupled to a first input 756 of a second multiplier 758. The output 744 of the first divider 738 is coupled to a second input 760 of the second multiplier 758. The serial output 737 of the first shift register 735 of the infinite logic signal aggregator 700 is coupled to a first input 762 of a third multiplier 764. The veracity control parameter α input 746 is coupled to a second input 766 of the third multiplier 764. An output 768 of the third multiplier 764 is coupled to a first input 770 of a second adder 772. An output 774 of the second multiplier 758 is coupled to a second input 776 of the second adder 772. An output 778 of the second adder 772 serves as an output of the veracity signal processor 702. The input-output processing of the veracity signal processor 702 can be described by the following equation:

Ver(α,β,d)=αd+(1−α)Inv_{β}(d) EQU. 4

where,
d ε [0,1] is the feature vector space distance input to the infinite logic signal inverter 706, applied at one of the inputs 708,
α ε [0,1] is the veracity control parameter input at 746;
β ε [−1,+infinity), is the nonlinearity control parameter applied at 718, and
Ver(α,β,d) ε [0,1] is the output of the veracity signal processor, produced at the output 778 of the second adder 772.

Note that the first term of equation four is the veracity control parameter α times the Identity Function of the distance, i.e., the distance itself. The second term is (1-α) times the inverse of the distance. Thus, the veracity function is bounded between the Identity Function and the inverse of the distance.

Referring again to FIG. 7, the infinite logic connective signal processor 704 will now be described. The output 778 of the second adder 772 is coupled to a first input 779 of a fourth multiplier 780. A connective control parameter λ_{A} input 781 is coupled to a second input 782 of the fourth multiplier 780. An output 783 of the fourth multiplier 780 is coupled to a first input 784 of a third adder 785. The fixed value (e.g., unity) 722 is coupled to a second input 786 of the third adder 785. An output 787 of the third adder 785 is coupled to a first input 788 of a fifth multiplier 789. An output 790 of the fifth multiplier 789 is coupled through a first buffer 791 and a second shift register 792 to a second input 793 of the fifth multiplier 789. The first buffer 791 is initialized with a value of one. Per the latter arrangement, the fifth multiplier 789 computes a product of a series of values received at the first input 788 of the fifth multiplier 789. The first buffer 791 is also coupled to a first input 794 of a third subtracter 795. The fixed value (e.g., unity) 722 is coupled to a second input 796 of the third subtracter.

The connective control parameter λ_{A} input 781 is also coupled to a first input 797 of a fourth adder 798. The fixed value (e.g., unity) 722 is coupled to a second input 799 of the fourth adder 798. An output 701 of the fourth adder 798 is coupled to a first input 703 of a sixth multiplier 705. An output 707 of the sixth multiplier 705 is coupled through a second buffer 709 and third shift register 711 to a second input 713 of the sixth multiplier 705. Note that the first, second and third shift registers 735,711, 792 are clocked in synchrony. The second buffer 709 is coupled to a first input 715 of a fourth subtracter 717. The fixed value (e.g., unity) 722 is coupled to a second input 719 of the fourth subtracter 717. The fourth subtracter 717 serves to subtract the fixed value (e.g., unity) 722 from the output of the second buffer 709. The output of the first buffer 791 and the second buffer 709 are output to the third subtracter 795 and the fourth subtracter 717 when final values based on all the distances received at the inputs 708 have been processed by the fifth multiplier 789 and the sixth multiplier 705. An output 721 of the fourth subtracter 717 is coupled to a denominator input 723 of a second divider 725. An output 727 of the third subtracter 795 is coupled to a numerator input 729 of the second divider 725. An output 731 of the second divider 725 is coupled to an output 733 of the adaptable infinite logic signal aggregator 700.

The input-output signal processing of the infinite logic aggregator 700 can be described by the following equation:

$${A}_{{λ}_{A}} ( {d}_{1} , … , {d}_{n} ) = \{ \begin{matrix}\frac{\begin{matrix}{\prod }_{i = 1}^{n} ( 1 + {λ}_{A} \cdot \\ Ver ( {α}_{i} , {β}_{i} , {d}_{i} ) ) - 1\end{matrix}}{{\prod }_{i = 1}^{n} ( 1 + {λ}_{A} ) - 1} & {λ}_{A} \geq - 1 , {λ}_{A} \neq 0 \\ \frac{1}{n} {\sum }_{i = 1}^{n} Ver ( {α}_{i} , {β}_{i} , {d}_{i} ) & {λ}_{A} = 0\end{matrix} \qquad EQU . 5$$

where,
dᵢ is the i^{th} per-unit distance values (e.g., produced by one of the distance metric computers 210, 214, 218);
αᵢ ε [0,1] is the veracity control parameter for the i^{th} distance;
βᵢ ε [−1, +infinity), is the nonlinearity control parameter for the i^{th} distance, and
Ver(αᵢ,βᵢ,dᵢ) ε [0,1] is the output produced by the veracity signal processor 702 in response the i^{th} distance;
λ_{A}>=−1 is the connective control parameter; and A_{λA}(d₁, . . . ,dₙ) is the output of the infinite logic aggregator 700.

The general functioning and versatility of the infinite logic aggregator 600, 700 for combining the distances computed by the hidden layer 209 of the ANN 110 is elucidated by FIGS. 8-18.

FIG. 8 is a graph 800 including a plot of the Identity Function 802 and several plots 804, 806, 808, 810, 812 of the input-output of the adaptable infinite logic inverter 706 obtained with five control parameter β settings −0.9, −0.5, 0.0, 1.0, 10.0. In all cases the infinite logic signal inverter matches the response of a binary logic Boolean inverter to with when the input is zero the output is one and when the input is one the output is zero. Also, in all cases the input-output of the inverter 706 is monotonic non-increasing. As shown in the graph, between zero and one the response of infinite logic signal inverter is configurable by adjusting the inverter nonlinearity control parameter β.

As evidenced in equation four the input-output relation of the veracity signal processor 702 is a weighted sum of the Identity Function and the input-output relation of the infinite logic inverter 706, with weights determined by the veracity control parameter α. Thus, the nonlinearity control parameter β and the veracity control parameter α afford two degrees of freedom that may be used to control the overall input-output relation of the veracity signal processor 702, and thus define the way in which the distances determined in the hidden layer 209 of the ANN 110 are initially processed (pre-processed) in the adaptable infinite logic aggregator 600, 700.

FIG. 9 is a graph 900 including several plots 902, 904, 906, 908, 910 showing the input-output response of the veracity signal processor 702. In graph 900 the abscissa indicates distance as measured in the hidden layer 209 of the ANN and the ordinate indicates the magnitude of the output of the veracity signal processor 702. The values of α and β for each plot are indicated in the graph 900. In interpreting the graph 900 it should be born in mind that typically the decision logic will classify the subject as belonging to the classification associated with the infinite logic aggregator node 236, 240, 244 that produces the lowest value. When β=0 the input output relation is linear as in plots 902, 906, 910. The parameter α determines whether the input-output relation is generally increasing, decreasing or flat (although for some combinations of parameters α and β the input-output relation is not linear, nor monotonic). Note that in a particular infinite logic aggregator e.g., 236, 240, 244 different values of α and β denoted αᵢ and βᵢ in equation five are used to process the distances received from different hidden layer nodes e.g., 210, 214, 218. Thus, the distance from one hidden layer node may be processed with an increasing veracity function, while the distance from another hidden layer node is processed with a decreasing function, etc. An increasing input-output relation signifies that the measured distance to a feature vector space reference point should be low for the measured subject to be assigned to a particular classification. On the other hand, a decreasing input-output relation signifies that the measured distance should be high. Put another way, an increasing input-output relation signifies that a positive inference is drawn when the measured distance is low and a decreasing input-output relation signifies that a negative inference is drawn when the measured distance is low. A flat input-output relation signifies that classification in a particular class is not particularly dependent on the measured distance in question, an no inference may be drawn based on it. Thus, unlike the case of a classic ANN that uses weighted links and sigmoid activation functions the parameters α and β have a higher level, more easily interpreted meaning, and thus judicious initial estimates, or working values for α and β can be more easily set by a designer of the ANN 110 based on inspection of feature vector data of a given pattern recognition application. As described below suitable final values of α and β can be found by optimization using training data.

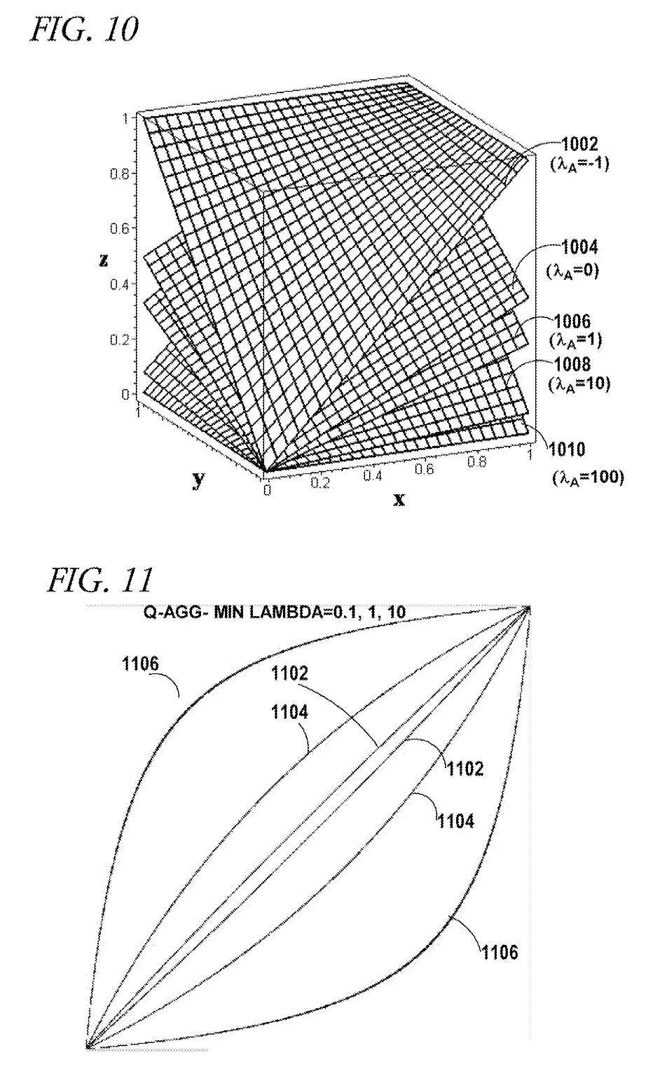

FIG. 10 shows 2-D surface plots 1002, 1004, 1006, 1008, 1010 of the input-output relation of the infinite logic connective signal processor 704 that is part of the adaptable infinite logic signal aggregator 700 shown in FIGS. 6-7. The infinite logic connective signal processor 704, also known by as the name Q-aggregator is covered in the co-pending patent application Ser. No. ______ (Docket No. CML02589T) entitled “Method and Apparatus for Nonlinear Signal and Data Aggregation” filed concurrently with the instant application. The input-output relation of the infinite logic connective signal processor 704 is described by the following equation:

$${A}_{{λ}_{A}} ( {a}_{1} , … , {a}_{n} ) = \{ \begin{matrix} \frac{{\prod }_{i = 1}^{n} ( 1 + {λ}_{A} {a}_{i} ) - 1}{{\prod }_{i = 1}^{n} ( 1 + {λ}_{A} ) - 1} & {λ}_{A} \geq 1 , {λ}_{A} \neq 0 \\ \frac{1}{n} {\sum }_{i = 1}^{n} {a}_{i} & {λ}_{A} = 0\end{matrix} \qquad EQU . 6$$

where, aᵢ ε [0,1] is an i^{th} input to the infinite logic connective signal processor 704 (received at 779); and

λ_{A}>=−1 is the connective control parameter.

When the connective control parameter λ_{A} is equal to minus one the input-output relation of the infinite logic connective signal processor 704 approximates the MAX function. In fuzzy logic systems the MAX function is considerate the lower limit of union (OR) functions. More precisely, when the connective control parameter λ_{A} is equal to minus one the input-output relation of the infinite logic connective signal processor 704 is above the MAX in part of the domain [0,1]^{N} and is below the max function in part of the domain [0,1]^{N}. When the connective control parameter λ_{A} is equal to zero the infinite logic connective signal processor 704 is configured as a linear signal averager. For high values of the connective control parameter λ_{A}, e.g., 100, the input-output relation of the infinite logic connective signal processor 704 approximates the MIN function. In fuzzy logic systems the MIN function is considered the upper limit of intersection (AND) functions. More precisely, when the connective control parameter is positive valued, the input-output relation of the infinite logic connective signal processor 704 is below MIN in part of the domain a ε [0,1]^{N} and is above the MIN function in part of the domain [0,1]^{N}.

FIG. 11 shows contour plots 1102, 1104, 1106 at which the input-output relation of the infinite logic connective signal processor 704 is equal to the MIN function for a few positive values of a control parameter λ_{A} of the infinite logic connective signal processor 704, i.e., 1102, when λ_{A}=0.1, 1104, when λ_{A}=1.0 and 1106, when λ_{A}=10.0. In the interior of each contour plot 1102, 1104, 1106 the output of the infinite logic connective signal processor 704 is less than the MIN function, exterior to each contour the output is greater than the MIN function. In fuzzy logic system, connective functions between the MIN and the MAX are referred to as averaging functions. In this context average is broader than the arithmetic mean, and includes generalized means with various exponents. It is worth noting here that even for a fixed positive value of the control parameter λ (e.g. λ=0.1), the infinite logic connective signal processor behaves either as a fuzzy intersection or average operator depending on the input values x and y. This characteristic of the infinite logic connective signal processor can provide for higher degrees of adaptivity required for modeling systems with highly dynamic nature, and also for compact representation of logical expressions. This characteristic also holds for cases with more than two inputs (e.g. A_{λ}(a₁, . . . ,aₙ)).

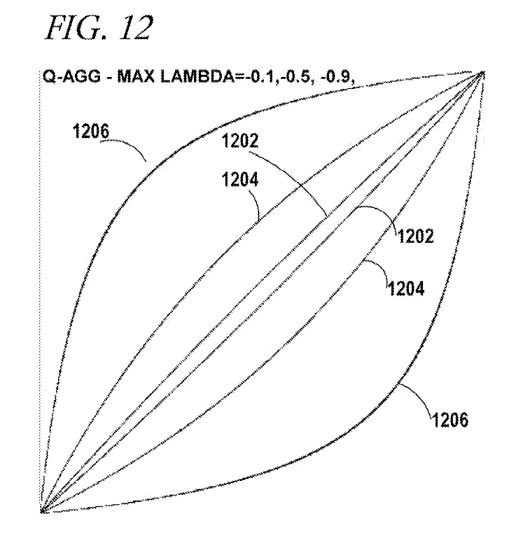

FIG. 12 shows contour plots 1202, 1204, 1206 at which the input-output relation of the infinite logic connective signal processor 704 is equal to the MAX function for a few negative values of the control parameter λ_{A} of the infinite logic connective signal processor 704, i.e., when λ_{A}=−0.1, 1202, when λ_{A}=−0.5, 1204, when λ_{A}=−0.9 1206. In the interior of each contour plot 1202, 1204, 1206 the output of the infinite logic connective signal processor 704 is greater than the MAX function and exterior to each contour the output is less than the MAX function.

Similarly, it is worth noting here that even for a fixed negative value of the control parameter λ (e.g. λ=−0.1), the infinite logic connective signal processor behaves either as a fuzzy union or average operator depending on the input values x and y. This characteristic of the infinite logic connective signal processor can provide for higher degrees of adaptivity required for modeling systems with highly dynamic nature, and also for compact representation of logical expressions. This characteristic also holds for cases with more than two inputs (e.g. A_{λ}(a₁, . . . ,aₙ)).

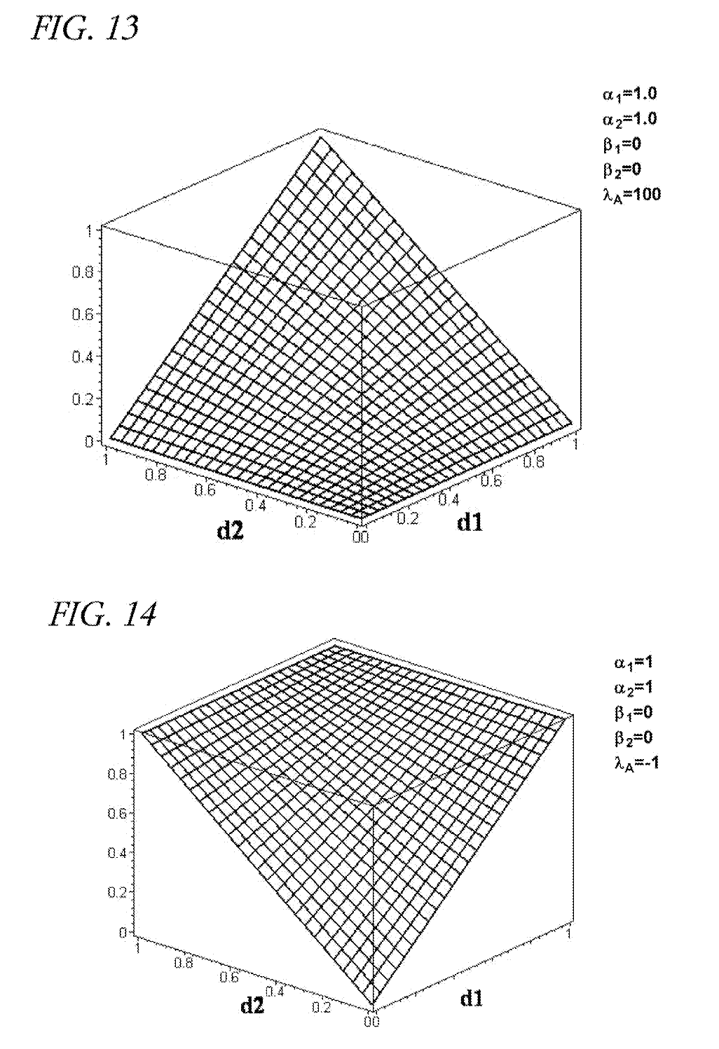

FIGS. 13-18 show 2-D surface plots of the input-output relation of the adaptable infinite logic signal aggregator 236, 240, 244, 600, 700 shown in FIGS. 2, 6, 7 with specific values of control parameters α, β, λ_{A}. The surface plots shown in FIGS. 13-18 are functions of two distance per-unit values (denoted d1, d2) conveyed from two distance metric computers in the hidden layer 209 of the ANN 110 and thus can be depicted as plots, however it should be understood that in practice each infinite logic signal aggregator in the output layer 245 of the ANN 110 may be connected to more than two distance metric computers in the hidden layer 209 of the ANN 110. In FIGS. 13-18 the independent variable axes represents distances received from the hidden layer 209 of the ANN 110, and the dependent variable value represents the output of the infinite logic signal aggregator (or partially determined output based on only two distances, if in fact there are more distance input to the output layer node). FIGS. 13-18 illustrate how the infinite logic signal aggregators 236, 240, 244 in the output layer 245 of the ANN 110 enhance the versatile of the ANN 110 by being able to implement a variety of fuzzy rules for combining the distances computed by the hidden layer 209 of the ANN. Values of the veracity control parameter α, inverter nonlinearity control parameter β and the connective control parameter λ_{A} used to generate each surface plot are shown in FIGS. 13-18. There are two values of α and β one for each distance, corresponding to distances d1 and d2. The interpretations of FIG. 13-18 given below assume that the decision logic 112 identifies the class corresponding to that infinite logic signal aggregators that produced the lowest output value.

As shown in FIG. 13 one of the infinite logic signal aggregators 236, 240, 244, 600, 700 is configured to identify a particular pattern classification when either a first distance d1 to a first feature vector (e.g., prototype feature vector) or a distance d2 to a second feature vector (e.g., prototype feature vector) is small. One example of a case in which the fuzzy rule implemented in FIG. 13 is appropriate is for a pattern recognition application in which feature vectors belonging to a single pattern classification are clustered in more than one cluster.

As shown in FIG. 14 one of the infinite logic signal aggregators 236, 240, 244, 600, 700 is configured to identify a particular pattern classification when both a first distance d1 to a first feature vector (call it c1) and a distance d2 to a second feature vector (call it c2) are small. The fuzzy rule shown in FIG. 14 tends to associate feature vectors in a region between c1 and c2 with the particular pattern classification.

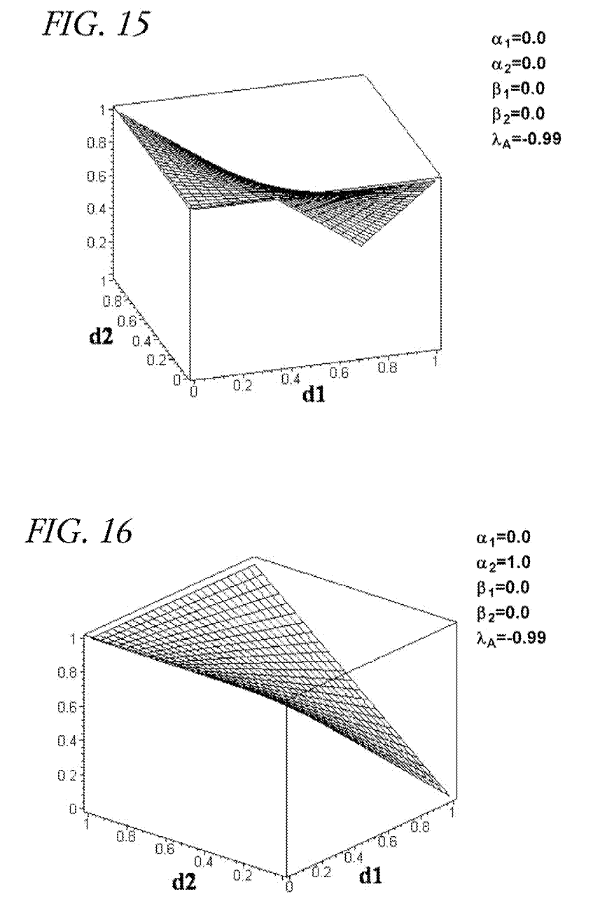

As shown in FIG. 15 one of the infinite logic signal aggregators 236, 240, 244, 600, 700 is configured to identify a particular pattern classification when both a first distance d1 to a first feature vector (call it c1) and a distance d2 to a second feature vector (call it c2) are large. In this case the particular pattern classification may be a default classification to which feature vectors that are neither close to c1 nor c2 are assigned. Other infinite logic signal aggregators in the same ANN could be configured to recognize feature vectors close to c1 and c2.

As shown in FIG. 16 one of the infinite logic signal aggregators 236, 240, 244, 600, 700 is configured to identify a particular pattern classification when a first distance d1 to a first feature vector (call it c1) is large and a distance d2 to a second feature vector (call it c2) is small. This fuzzy rule is very conservative in classifying feature vectors in a classification associated with c2. Input feature vectors must be close to c2 as well as far from c1.

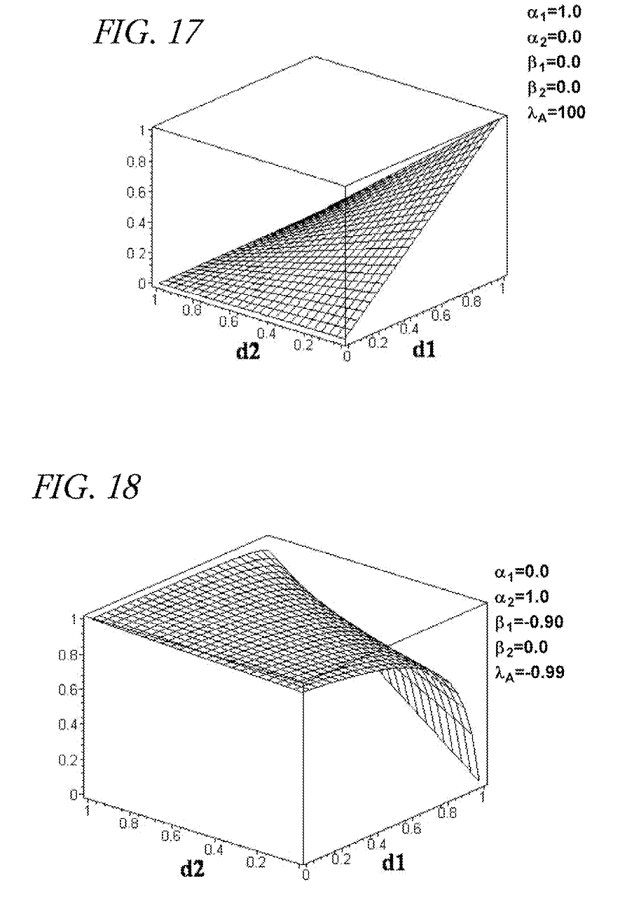

As shown in FIG. 17 one of the infinite logic signal aggregators 236, 240, 244, 600, 700 is configured to identify a particular pattern classification when either a first distance d1 to a first feature vector (call it c1) is small OR a distance d2 to a second feature vector (call it c2) is large. Assuming the case that one classification is associated with feature vector c1 and another classification with feature vector c2, the fuzzy rule shown in FIG. 17 biases classification toward the classification associated with c1.

In the case of the fuzzy rules illustrated in FIGS. 13-17 the inverter nonlinearity control parameters β₁, β₂ were zero yielding a linear input-output response for the infinite logic inverter 706. FIG. 18 shows the input-output response when the control parameters used to obtain the fuzzy rule shown in FIG. 16 are changed by setting β₁=−0.9. The new fuzzy rule is qualitatively the same as shown in FIG. 16, but more conservative, in that the distance d1 must be larger for similarly low values of the output to be obtained. Thus the parameters β₁, β₂ provide additional degrees of freedom for fine tuning the fuzzy rules implemented by the infinite logic signal aggregators 236, 240, 244, 600, 700. By using a configurable distance metric computer such as shown in FIG. 4 or one based on another non-Euclidean distance metric, hidden layer nodes can be better adapted to the shapes of clusters of feature vectors encountered in a given pattern recognition application. Then by using the adaptable infinite logic aggregators 236, 240, 244, 600, 700 to process the distances, a high degree of versatility can be achieved for the task of assigning input feature vectors to classifications based on the distances computed by the distance metric computers.

An engineer implementing an ANN according to the teachings herein can choose values of metric control parameters (e.g., λ_{D}, wᵢ) based on examinations of shapes of clusters of training feature vectors and guided by FIGS. 13-18 as well as equations 4-6 can choose values of the veracity control parameters αᵢ, the inverter nonlinearity control parameters βᵢ and the connective control parameter λ_{A} in order to implement a particular fuzzy rule. Some trial and error experimentation could be used to choosing the nonlinearity control parameters βᵢ. On the other hand, an optimization system may be used to select the control parameters of the ANN.

FIG. 19 is a block diagram of a system 1900 for training the artificial neural network 110 shown in FIG. 2. The system 1900 includes a training data memory 1902. The training data memory 1902 stores training input feature vectors 1904 and associated classification labels 1906 for the input feature vectors 1904. The training input feature vectors 1904 are produced by measuring subjects of known classification with the sensors 102, converting the measured data with the D/A 106 and processing the digital output of the D/A 106 with the feature vector extractor 108. Each training input feature vector 1904 has an associated label 1906. An example of an input feature vector is [0.98, 0.75, 0.43, 0.38].

The training input feature vectors 1904 are applied to the ANN 110 undergoing training (optimization). The labels 1906 are applied to a first input 1908 of an objective function computer 1910. The output of the ANN 110 under training that is produced in response to the input feature vectors 1904 is processed by the decision logic 112 discussed above. The decision logic also outputs a class label. The class label produced by the decision logic 112 is applied to a second input 1908 of a the objective function computer 1910. The objective function computer 1910 counts the total number training input feature vectors 1904 and correct classifications and computes an objective function such as:

$$OBJ = \frac{C}{m} \qquad EQU . 7$$

where, C is the number of correct classifications; and
m is the number of training input feature vectors.

An output 1914 of the objective function computer 1910 at which values of the objective function are output is coupled to an input 1916 of a training supervisor 1918. The training supervisor 1918 suitably comprises a nonlinear optimization program, for example a program that implements a direct search method such as the Nelder-Mead algorithm, a Simulated Annealing Algorithm, a Genetic Algorithm, or a Differential Evolution algorithm. The training supervisor 1918 is coupled to a parameter memory 1920 for parameters (e.g., αᵢ, βᵢ, λ_{A}, λ_{D}, wᵢ) of the distance metric computer nodes and infinite valued logic aggregator nodes used in the ANN 110 under training. The training supervisor optimizes values of the parameters in order to minimize the value of the objective function. When the objective function is minimized the ANN 110 will have been trained for pattern recognition.

FIG. 20 is a flowchart of a method 2000 of training the ANN 110 shown in FIG. 2. In block 2002 parameters (e.g., λ_{D}, wᵢ) of the distance metric nodes 210, 214, 218 are initialized and in block 2004 the parameters (e.g., αᵢ, βᵢ, λ_{A}) of the infinite logic aggregators 236, 240, 244 are initialized. Each of the parameters may be initialized to a random value within the allowed range for the particular parameter. Block 2006 starts with a first training input feature vector. In block 2008 a currently selected training input feature vector (initially the first) is applied to the neural network 110 under training. In block 2010 a sub-expression (e.g., inner sum of equation 7) of an objective function (e.g., equation 7) is evaluated based on the associated binary output vector and the output produced in response to the currently selected training input feature vector. Decision block 2012 tests if there are more training input feature vectors in a training data set that is being used that remain to be processed. If so, then block 2014 gets a next training input feature vector, and thereafter the method 2000 loops back to block 2008. If, on the other hand, it is determined in block 2012 that there is no more training data to be used, then the method 2000 branches to block 2016 in which a final value (e.g., outer sum of equation 7) is computed. Thereafter, block 2018 tests if an optimization stopping criteria has been met. If not then the method 2000 continues with block 2020 in which the parameters of the distance metric nodes (e.g., λ_{D}, wᵢ) and the parameters (e.g., αᵢ, βᵢ, λ_{A}) of the infinite logic aggregators 236, 240, 244 are updated based on an optimization strategy, such as, for example, one of the direct search methods mentioned above. After block 2020, the method returns to block 2006 and proceeds as described above. If, on the other hand, it is determined in block 2018 that the stopping criteria has been met, then the method 2000 branches to block 2022 in which final values of the parameters are output. The method 2000 can be implemented in software, that is stored on a computer readable medium and executed by a programmed processor.

FIG. 21 is a block diagram of a regression neural network 2100 according to an embodiment of the invention. The input layer and the hidden layer 209 of the regression neural network 2100 are the same as the ANN 110. However, the output layer 235 of the ANN 110 is replaced with a second hidden layer 2102 in the regression neural network 2100 and the connections from the hidden layer 209 to the second layer 2102 are different in the regression neural network 2100. In particular, the output 232 of the first distance metric computer 210 is coupled to an input 2104 of a first infinite logic inverter 2106; the output 246 of the second distance metric computer 214 is coupled to an input 2108 of a second infinite logic inverter 2110; and the output 254 of the N^{TH} distance metric computer 218 is coupled to an input 2112 of an N^{TH} infinite logic inverter 2114. The infinite logic inverters 2106, 2110, 2114 of the regression neural network 2100 may have the internal design of the infinite logic inverter 706 shown in FIG. 7, the operation of which is described by equation three. An output 2116 of the first infinite logic inverter 2106, an output 2118 of the second infinite logic inverter 2110, and an output 2120 of the N^{TH} infinite logic inverter 2114 are coupled to a first input 2122, a second input 2124 and an NTH input 2126 respectively of a weighted summer 2128.

The operation of the regression neural network 2100 can be described by the following equation:

$$f ( x ) = \frac{{\sum }_{i = 1}^{n} {f}_{i} \cdot {Inv}_{β} ( {d}_{{λ}_{Di}} ( x , {c}_{i} ) )}{{\sum }_{i = 1}^{n} {Inv}_{β} ( {d}_{{λ}_{Di}} ( x , {c}_{i} ) )} \qquad EQU . 8$$

where,
x is an input feature vector;
cᵢ is an i^{TH} center from which distance is measured by the i^{TH} distance metric computer (e.g., 210, 214, 246);
fᵢ is a weight.

Note that fᵢ is also a dependent variable value corresponding to independent variable vector cᵢ. Thus, tuples (cᵢ, fᵢ) may represent known function points, that are used to configure the regression neural network 2100. The values of the parameters of the metric (e.g., λ_{D}, wᵢ) and of the inverter (e.g., β) can be chosen using a direct search method (e.g., those mentioned above) in order to minimize sum of the squares of the differences between the output of the regression neural network 2100 that is produced in response to independent variable data, and known dependent variable values associated with the independent variable data. The values of (cᵢ, fᵢ) can also be subjected to optimization by direct search.

Another way to compute the distance metric given by equation one is by the following recursion relation.

Ψᵢ=wᵢ|xᵢ−yᵢ|+Ψᵢ₋₁+λwᵢ|xᵢ−yᵢ|Ψᵢ₋₁ EQU. 9

starting with an initial function value:

Ψ₀=0

up to subscript P where P is the dimensionality of the vectors x and y. The distance metric given by equation one is also equal to:

d_{λ}(x,y)=Ψ_{P}

FIG. 22 is a block diagram of an implementation of the configurable feature vector distance computer 2200 that uses efficient recursive computation based on equation nine. Referring to FIG. 22, a first vector memory 2252 and a second vector memory 2254 are coupled to a first input 2256 and a second input 2258 of a subtracter 2260. The feature vector distance computer 2200 computes a non-Euclidean distance between the first vector and the second vector. An output 2262 of the subtracter 2260 is coupled to an input 2264 of a magnitude computer 2266. The subtracter 2260 computes a vector difference between the first vector 2252 and the second vector 2254 and outputs a set of component differences. The magnitude computer 2266 computes the absolute value of each component difference. An output 2268 of the magnitude computer 2266 is coupled to a first input 2270 of a first multiplier 2272. A dimension weight memory 2274 is coupled to a second input 2276 of the first multiplier 2272. The first multiplier 2272 weights (multiplies) each absolute value vector component difference by a weight stored in the dimension weight memory 2274.

The weighted, absolute values of the vector component differences, denoted δᵢ are output at an output 2278 of the multiplier 2272 that is coupled through a buffer 2280 to a first input 2282 of a recursive lambda rule engine 2299. The absolute values of the vector component differences 61 are supplied to a first input 2206 of a second multiplier 2204. The second multiplier 2204 receives the metric control parameter λ_{D} at a second input 2208. The metric control parameter λ_{D} is received through a second input 2284 of the recursive lambda rule engine 2299 from a parameter register 2286. The second multiplier 2204 outputs a series of products λ_{D}δᵢ at an output 2210.

The output 2210 of the second multiplier 2204 is coupled to a first input 2212 of a third multiplier 2214. The second multiplier 2204 in combination with the third multiplier 2214 form a three input multiplier. One skilled in the art will appreciate that signals input to the second multiplier 2204 and the third multiplier 2214 may be permuted among the inputs of the second multiplier 2204 and third multiplier 2214 without changing the functioning of the engine 2299. An output 2216 of the third multiplier 2214 is coupled to a first input 2218 of a first adder 2220. A second input 2222 of the first adder 2220 sequentially receives weighted absolute values of the differences 61 directly from the first input 2282. An output 2224 of the first adder 2220 is coupled to a first input 2226 of a second adder 2228. Accordingly, the first adder 2220 and the second adder 2228 form a three input adder.

An output 2230 of the second adder 2228 is coupled to a first input 2232 of a multiplexer 2234. A second input 2236 of the multiplexer 2234 is couple to an initial value register 2288. A control input 2238 of the multiplexer 2234 (controlled by a supervisory controller not shown) determines which of the first input 2232 and second input 2326 is coupled to an output 2240 of the multiplexer 2234. Initially the second input 2236 which is coupled to the initial value register 2288 is coupled to the output 2240. For subsequent cycles of operation of the recursive lambda rule engine 2299 the first input 2232 of the multiplexer 2234 which is coupled to the output 2230 of the second adder 2228, is coupled to the output of the multiplexer 2234 so that the engine 2299 operates in a recursive manner.

The output 2240 of the multiplexer 2234 is coupled to an input 2242 of a shift register 2244. An output 2246 of the shift register 2244 is coupled to a second input 2248 of the second multiplier 2214 and to a second input 2250 of the second adder 2228.

During each cycle of operation, the output of the second multiplier 2204 is λ_{D}δᵢ, the output of the second multiplier 2214 is λ_{D}δᵢ ψᵢ₋₁ (the third term in equation nine), the output of the first adder 2220 is δᵢ+λ_{D}δᵢ ψᵢ₋₁, and the output of the second adder 2228 is ψᵢ₋₁+δᵢ+λ_{D}δᵢ ψᵢ₋₁, which is the right hand side of equation nine. After P cycles of operation the output of the second adder 2228 will be the distance metric.

A generalization of the infinite logic connective signal processor is described by the following equation:

$${A}_{{λ}_{A}} ( {a}_{1} , … , {a}_{n} ) = \{ \begin{matrix} \frac{{\prod }_{i = 1}^{n} ( 1 + {λ}_{A} {w}_{i} {a}_{i} ) - 1}{{\prod }_{i = 1}^{n} ( 1 + {λ}_{A} {w}_{i} ) - 1} & {λ}_{A} \geq - 1 , {λ}_{A} \neq 0 \\ \frac{{\sum }_{i = 1}^{n} {w}_{i} {a}_{i}}{{\sum }_{i = 1}^{n} {w}_{i}} & {λ}_{A} = 0\end{matrix} \qquad EQU . 10$$

where, wᵢ ε [0,1] is a weight for the i^{th} input; and other terms are defined above with reference to equation six.

By evaluating the recursion relation:

Ψᵢ=wᵢaᵢ+Ψᵢ₋₁+λ_{A}wᵢaᵢΨᵢ₋₁ EQU. 11

starting with an initial function value:

Ψ₀=0

until ψ_{N} is obtained, evaluating the recursion relation:

Ψᵢ=wᵢ+Ψᵢ₋₁+λ_{A}wᵢΨᵢ₋₁ EQU. 12

starting with an initial function value:

Ψ₀=0

until ψ_{N} is obtained and dividing the result of evaluating equation 11 up to N by the result of evaluating equation 12 up to N, a result equivalent to that given by equation 10 is obtained. By setting all of the weights wi to one, the result of equation six is obtained. Both equation 11 and equation 12 can be evaluated using the recursive lambda rule engine 2299 shown in FIG. 22.

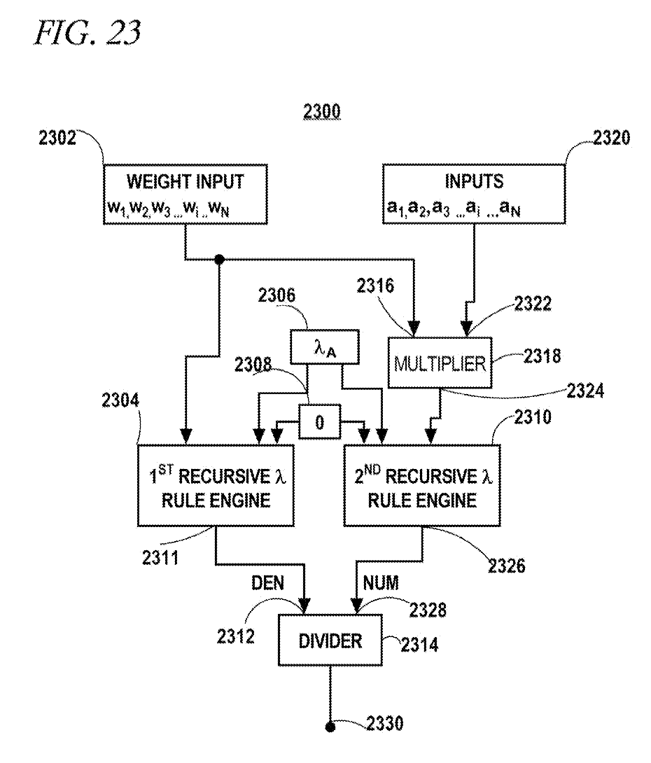

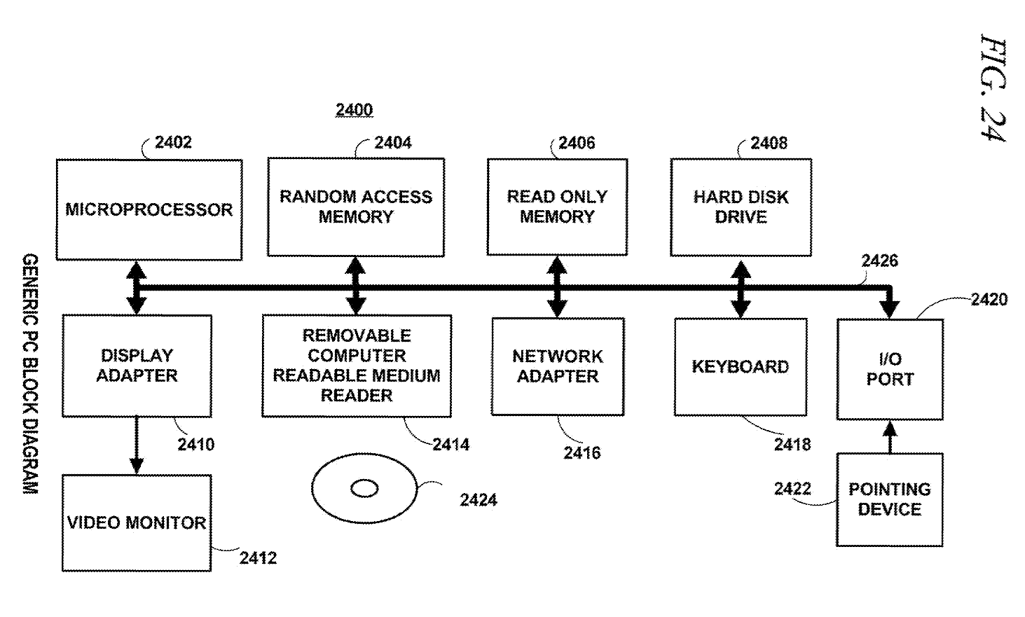

FIG. 23 is a block diagram of an implementation of an infinite logic connective signal processor 2300 that uses efficient recursive computation. Referring to FIG. 23, a sequence of input weights wᵢ are input through a weight input 2302 that is coupled to a first recursive lambda rule engine 2304. The control parameter λ_{A} is input via a control parameter input 2306 that is also coupled to the first recursive lambda rule engine 2304. Also, an initial value of zero is input via a zero input 2308. The multiplexer 2234 of the first recursive lambda rule engine 2304 and of a second recursive lambda rule engine 2310 are initially set to pass the zero from the zero input 2308. The first recursive lambda rule engine 2304 is operated until the value ψ_{N} (given by equation 12) is computed. The value Of ψ_{N} is coupled from an output 2311 of the first recursive lambda rule engine 2304 to a denominator input 2312 of a divider 2314.

The sequence of input weights wᵢ are also coupled to first input 2316 of a multiplier 2318. An input 2320 of the infinite logic connective signal processor 2300 for receiving the values aᵢ to be aggregated is coupled to a second input 2322 of the multiplier 2318. The multiplier 2318 outputs a sequence of products wᵢaᵢ. An output 2324 of the multiplier 2318 is coupled to the second recursive lambda rule engine 2310. (Note that the recursive lambda rule engines 2299 shown in FIG. 22 can be used in the connective signal processor 2300 as 2304 and 2210) The second recursive lambda rule engine 2310 is operated until the value ψ_{N} (given by equation 11) is computed. The value of ψ_{N} computed by the second recursive lambda rule engine 2310 is coupled from an output 2326 of the second recursive lambda rule engine 2310 to a numerator input 2328 of the divider 2314. An output 2330 of the divider 2314 outputs the output A_{λA}(a₁, . . . ,aₙ) of the infinite logic connective signal processor 2300.

In the case λ=0 the first recursive lambda rule engine 2304 produces the denominator of equation ten for the case λ=0, i.e., the sum of the weights wᵢ, and the second recursive lambda rule engine 2310 produces the numerator of equation six for the case λ=0, i.e., the weighted sum of the inputs aᵢ. Thus the infinite logic connective signal processor 2300 can handle the full range of values of the control parameter λ>=−1.

FIG. 24 is a block diagram of a computer 2400 that is used to run software implementations of the systems disclosed herein according to certain embodiments of the invention. The computer 2400 comprises a microprocessor 2402, Random Access Memory (RAM) 2404, Read Only Memory (ROM) 2406, hard disk drive 2408, display adapter 2410, e.g., a video card, a removable computer readable medium reader 2414, a network adaptor 2416, a keyboard 2418, and an I/O port 2420 communicatively coupled through a digital signal bus 2426. A video monitor 2412 is electrically coupled to the display adapter 2410 for receiving a video signal. A pointing device 2422, e.g., a mouse, is coupled to the I/O port 2420 for receiving signals generated by user operation of the pointing device 2422. The network adapter 2416 can be used, to communicatively couple the computer 2400 to an external source of data, e.g., a remote server. The computer readable medium reader 2414 preferably comprises a Compact Disk (CD) drive. A computer readable medium 2424, that includes software embodying the programs described above is provided. The software included on the computer readable medium 2424 is loaded through the removable computer readable medium reader 2414 in order to configure the computer 2400 to carry out programs of the current invention that are described above with reference to the FIGs. The computer 2400 may for example comprise a personal computer or a work station computer. Computer readable media used to store software embodying the programs described above can take on various forms including, but not limited to, magnetic media, optical media, and semiconductor memory.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An artificial neural network comprising:
a plurality of signal inputs for receiving an input signal vector;
at least one hidden layer comprising a plurality of hidden signal processing nodes, wherein each of the plurality of hidden signal processing nodes is coupled to a plurality of said signal inputs, and wherein each particular hidden signal processing node is adapted to compute a distance between said input signal vector and a predetermined center associated with said particular hidden signal processing node, and wherein each hidden signal processing node comprises an output for outputting a function of said distance;
a plurality of output nodes, wherein each particular output node comprises a plurality of output node inputs and an output node output, wherein each output node input is coupled to said output of one of said plurality of hidden nodes, and wherein each particular output node is adapted to combine signals received at its plurality of inputs with infinite valued logic, and thereby produce an output signal that is output at the output node output.

2. The artificial neural network according to claim 1 wherein said function of said distance is the Identity Function of said distance.

3. The artificial neural network according to claim 1 wherein:
each particular hidden signal processing node is adapted to compute a non-Euclidean distance between said input signal vector and said predetermined center.

4. The artificial neural network according to claim 3 wherein:
each particular hidden signal processing node is adapted to compute a distance metric defined by:
$${d}_{{λ}_{D}} ( x , y ) = \frac{{\prod }_{i = 1}^{P} ( 1 + {λ}_{D} {w}_{i} \vert {x}_{i} - {y}_{i} \vert ) - 1}{P {λ}_{D}}$$
where,
λ_{D} ε [−1,0) is the metric control parameter;
xᵢ ε [0,1] is an i^{th} component of a said input signal vector;
yᵢ ε [0,1] is an i^{th} component of said predetermined center;
P is a dimensionality of said input signal vector and said predetermined center;
wᵢ ε [0,1] is an i^{th} dimension weight; and
d_{λD} (x,y) ε [0,P] is said distance.

5. The artificial neural network according to claim 1 wherein:
one or more of said output nodes comprises a veracity signal processor that is adapted to receive said function of said distance from one or more of said hidden signal processing nodes and to produce a veracity signal wherein said veracity signal is a weighted sum of a monotonic non-decreasing function of said function of said distance and an infinite logic inverse of said function of said distance.

6. The artificial neural network according to claim 5 wherein said monotonic non-decreasing function is the Identity Function.

7. The artificial neural network according to claim 5 wherein:
one or more of said output nodes comprises an infinite logic signal connective signal processor adapted to combine said veracity signals produced from said function of said distance received from said one or more hidden signal processing nodes in order to produce said output signal of said output node.

8. The artificial neural network according to claim 7 wherein said infinite logic connective signal processor has an input-output relation described by:
$${A}_{{λ}_{A}} ( {a}_{1} , … , {a}_{n} ) = \{ \begin{matrix} \frac{{\prod }_{i = 1}^{n} ( 1 + {λ}_{A} {a}_{i} ) - 1}{{\prod }_{i = 1}^{n} ( 1 + {λ}_{A} ) - 1} & {λ}_{A} \geq 1 , {λ}_{A} \neq 0 \\ \frac{1}{n} {\sum }_{i = 1}^{n} {a}_{i} & {λ}_{A} = 0\end{matrix}$$
where,
aᵢ ε [0,1] is an i^{th} input to the infinite logic connective signal processor; and
λ_{A}>=−1 is the connective control parameter.

9. The artificial neural network according to claim 7 wherein:
said infinite logic connective signal processor is configurable by a first control parameter to operate as an infinite logic intersection, an infinite logic union operation operator, and between the infinite logic intersection and the infinite logic union operators.

10. The artificial neural network according to claim 9 wherein:
said infinite logic inverse has an input output relation that is determined by a second control parameter.

11. The artificial neural network according to claim 10 wherein:
operation of said infinite logic inverse is substantially described by the following equation:
$${Inv}_{β} ( d ) = \{ \begin{matrix} \frac{1 - d}{1 + β d} & d \neq 1 \\ 0 & d = 1\end{matrix}$$
where, d ε [0,1] is said function of said distance, and
β ε [−1,+infinity), is said second control parameter.

12. A pattern recognition system comprising:
a sensor for measuring a subject to be recognized and producing measurement data;
a feature vector extractor coupled to said sensor for receiving said measurement data, wherein said feature vector extractor is adapted to generate a feature vector from said measurement data;
a neural network according to claim 1 coupled to said feature vector extractor for receiving said feature vector as said input signal vector at said plurality of signal inputs;
decision logic coupled to said output node output of said plurality of output nodes, wherein said decision logic is adapted to output an identification of a classification associated with an output node that output a lowest signal.

13. A regression neural network comprising:
a plurality of signal inputs for receiving an input signal vector;
a first hidden layer comprising a plurality of distance metric computer nodes, wherein each of the distance metric computer nodes is coupled to a plurality of said signal inputs, and wherein each particular distance metric computer node is adapted to compute a distance between said input signal vector and a center associated with said particular distance metric computer node;
a second hidden layer comprising a plurality of inverter nodes, wherein each of said plurality of inverter nodes is coupled to one of said distance metric computer nodes in said first hidden layer, and wherein each inverter node is adapted to compute a monotonic non-increasing function of said distance received from said one of said distance metric computer nodes, and wherein each inverter node comprises an output for outputting a value of said monotonic non-increasing function of said distance; and
an output node coupled to said output of said plurality of inverter nodes, said output node comprising an output node output, and wherein said output node is adapted to compute a weighted sum of said value received from said plurality of inverter nodes.

14. The regression neural network according to claim 13 wherein said plurality of inverter nodes have input-output relations that are controllable by adjusting a control parameter.

15. The regression neural network according to claim 13 wherein:
each particular distance metric computer nodes is adapted to compute a non-Euclidean distance metric between said input signal vector and said center associated with said particular distance metric computer node.

16. The regression neural network according to claim 15 wherein:
each particular distance metric computer node is adapted to compute a distance metric defined by:
$${d}_{{λ}_{D}} ( x , y ) = \{ \begin{matrix} \frac{{\prod }_{i = 1}^{P} ( 1 + {λ}_{D} {w}_{i} \vert {x}_{i} - {y}_{i} \vert ) - 1}{P {λ}_{D}} & {λ}_{D} = [ - 1 , 0 ) \\ \frac{1}{P} {\sum }_{i = 1}^{P} {w}_{i} \vert {x}_{i} - {y}_{i} \vert & {λ}_{D} = 0\end{matrix}$$
where,
λ_{D} ε [−1,0] is a metric control parameter;
xᵢ ε [0,1] is an i^{th} component of said input signal;
yᵢ ε [0,1] is an i^{th} component of said predetermined center;
P is a dimensionality of said input signal vector and said predetermined center;
wᵢ ε [0,1] is an i^{th} dimension weight; and
d_{λD} (x,y) ε [0,P] is said distance.

17. A veracity signal processor comprising:
an input for receiving an input signal:
an infinite logic inverter coupled to said input, wherein said infinite logic inverter is adapted to invert said input signal an produce an inverter output signal;
a first multiplier coupled to said infinite logic inverter for receiving said inverter output signal, wherein said first multiplier is adapted multiply said inverter output signal by a first weight and output a weighted inverter output signal;
a second multiplier coupled to said input, wherein said second multiplier is adapted to multiply said input signal by a second weight and produce a weighted input signal;
a first adder coupled to said first multiplier and said second multiplier, wherein said first adder is adapted to add said weighted inverter output signal and said weighted input signal and output a veracity signal.

18. The veracity signal processor according to claim 17 wherein:
said inverter comprises:
a third multiplier coupled to said input, wherein said third multiplier is adapted to multiply said input signal by a nonlinearity control parameter and output a product of said input signal and said nonlinearity control parameter;
a subtracter coupled to said input, wherein said subtracter is adapted to subtract said input signal from a constant and output a difference;
a second adder coupled to said third multiplier and a constant, wherein said second adder is adapted to add said constant to said product of said input signal and said nonlinearity control parameter and output a sum;
a divider coupled to said subtracter and said adder, wherein said divider is adapted to divide said difference by said sum and output said inverter output signal.

19. The veracity signal processor according to claim 17 wherein:
a weight selected from a group consisting of said first weight and said second weight are equal to a veracity control parameter; and
a sum of said first weight and said second weight is equal to one.

20. The veracity signal processor according to claim 18 wherein operation of the veracity signal processor is described by:
$$Ver ( α , β , d ) = α d + ( 1 - α ) {Inv}_{β} ( d )$$
$$where , \\ {Inv}_{β} ( d ) = \{ \begin{matrix} \frac{1 - d}{1 + β d} & d \neq 1 \\ 0 & d = 1\end{matrix}$$
d ε [0,1] is the input signal;
α ε [0,1] is the veracity control parameter;
βε [−1,+infinity), is a nonlinearity control parameter that controls a nonlinearity of the inverter;
Inv_{β}(d) ε [0,1] is the output of the infinite logic inverter;
Ver(α,β,d) ε [0,1] is the output of the veracity signal processor.
